(19) United States
(12) Patent Application Publication
(10) Pub. No.: US 2004/0003678 A1
(43) Pub. Date: Jan. 8, 2004

(54) Device and method for balancing rotating systems

(76) Inventors: Achim Neubauer, Sinzheim-Vormberg (DE); Martin-Peter Bolz, Buehl (DE); Jochen Moench, Sinzheim (DE); Hartmut Krueger, Buehlertal (DE)

Correspondence Address: Striker Striker & Stenby, 103 East Neck Road, Huntington, NY, 11743, US

(21) Appl. No.: 10/332,342

(22) PCT Filed: Apr. 17, 2002
(86) PCT No.: PCT/DE02/01415

(30) Foreign Application Priority Data
May 11, 2001 (DE) 101 23 031.1

(51) Int. Cl. F16F 15/22

(52) U.S. Cl. 74/573 R

(57) ABSTRACT

The invention relates to an apparatus and a method using the apparatus for automatically balancing rotating systems (12), having at least one travel path, disposed about the pivot axis (18) of the system (12), for at least one movable balancing body (522).

It is proposed that the apparatus (510) have a closed revolution conduit (520), extending concentrically about the pivot axis (18), in which conduit the at least one balancing body (522) can orbit around the pivot axis (18) of the system over at least one of the existing travel paths open toward one another.

### PRIOR ART

The present invention relates to a method and an apparatus for dynamically balancing rotating systems.

Rotating systems are balanced in order to eliminate or reduce vibrations that occur in the system from imbalance. These unwanted vibrations can, among other effects, lead to irritating noises or—because of the greater load on the bearings—to a shortening of the service life of the particular rotating system.

In addition to static balancing, in which a defined exemplary embodiment mass is fixedly mounted on or removed from a previously determined point of the rotating system, so-called automatic balancing has also long been known. In this method, balancing bodies are used that are movable about the pivot axis of the rotating system.

In automatic balancing, the balancing bodies that are movable about the pivot axis of the rotating system order themselves automatically in such a way that the forces of inertia from the original imbalance are reduced, and the unwanted vibrations of the system are as a result damped or even eliminated entirely.

The theoretical principles of automatic balancing of rotating, elastically suspended systems are described at length in the literature, for instance in the book by Kellenberger entitled “Elastisches Wuchten: Modale Verfahren, EK-Technik, Sondertechniken, Automatisches und Thermisches Wuchten” [“Elastic Balancing: Modal Methods, EK Technique, Special Techniques, Automatic and Thermal Balancing”], published by Springer Verlag in Berlin and Heidelberg in 1987.

The incorporation of such dynamic systems in all rotating parts that otherwise would have to be statically balanced has advantages, because that time-consuming production step is dispensed with entirely. Moreover, the applicable component is continuously rebalanced in operation, so that even imbalances that change over the course of operation or that even arise only during operation (for instance from wear, defects, dirt, or corrosion) are always automatically compensated for.

From U.S. Pat. No. 5,724,862, a method for automatically eliminating imbalances of a rotating body is already known. This method comprises the disposition of a balancing apparatus about the pivot axis of the rotating system that has a plurality of closed paths, disposed concentrically about the pivot axis, in each of which at least one balancing body can orbit.

The use of a plurality of concentric travel paths with different radii makes it possible for the rotating system to be balanced over a wide rpm range and in the event of especially great fluctuations in the imbalances of the rotating system.

A disadvantage of the method, described in U.S. Pat. No. 5,724,862, for dynamic balancing of rotating bodies is, among others, that the balancing apparatus that carries the travel paths of the balancing bodies is relatively large, relatively complex in its construction, and thus also relatively heavy.

The object of the present invention is to create a method and an apparatus for performing a method for dynamic imbalance elimination in rotating systems that permits balancing over the widest possible range of imbalances and rotary speeds, with the simplest, smallest and lightest possible structure.

This object is attained by the invention presented here having the characteristics recited in claims 1 and 10.

### ADVANTAGES OF THE INVENTION

The method of the invention and the apparatus, functioning by this method, for balancing rotating systems has the advantage that a plurality of concentric travel paths of different radii can be integrated with very little effort or expense into a single revolution conduit. The use of a single revolution conduit that solely by its cross-sectional shape defines the various travel paths for the balancing masses, makes it possible to achieve a balancing apparatus of the generic type in question that requires comparatively little installation space.

The use of travel paths that are open toward one another makes a complicated mechanical separation of the individual travel paths by means of walls unnecessary. Along with the attendant savings in terms of material, weight and volume, the costs for the apparatus of the invention are also correspondingly reduced in comparison with systems of the prior art.

The reduced installation volume and weight of the apparatus of the invention makes it possible to employ the method presented here for dynamic balancing in many rotating systems, even of small size.

By means of the provisions and details recited in the dependent claims, advantageous refinements of and improvements to the apparatus defined by claim 1 are possible.

By means of a special shaping of the cross-sectional contour of the one revolution conduit, it is possible in a simple and advantageous way to embody various travel paths for the balancing masses of the apparatus of the invention. It is no longer necessary to have a plurality of self-contained revolution conduits, with the requisite partitions, to create different travel paths for the balancing masses about the pivot axis of the system.

In particular, the various travel paths can be dimensioned in such a way that a plurality of balancing bodies of various sizes can orbit the common pivot axis of the applicable system over the travel paths. In this way, an arrangement of balancing bodies of various sizes and masses can advantageously be achieved over different orbit radii about the common pivot axis of the system.

The balancing bodies involved can be disposed in both the radial and the axial directions solely by way of the cross-sectional contour of the revolution conduit. Staggering of the balancing bodies by their size or mass over the various orbit radii can thus be achieved in a very simple and advantageous way with the apparatus of the invention.

The use of a plurality of balancing bodies of different masses over different travel paths about the same pivot axis makes it possible to reduce the imbalance of the system over a wide rpm range. A system with balancing bodies of different masses that orbit on different paths inside the apparatus of the invention can furthermore be adapted more finely, since the remaining residual imbalance that would result if only one travel path were used can be reduced still further by means of a second travel path and balancing masses adapted accordingly. Increasing the number of possible travel paths thus makes it possible to minimize the extent of the remaining imbalance. The apparatus of the invention makes it possible for the installation space, which increases as the number of orbit paths increases, and the correspondingly increasing costs to be reduced, compared to the apparatuses of the prior art.

The use of balls as orbiting balancing bodies of the apparatus of the invention reduces friction losses and brings about a corresponding reduction in the noise level of the automatically balanced system in operation.

Especially the use of balls of different diameters as balancing masses makes a simple separation of the individual travel paths of the balancing bodies possible within the single, closed revolution conduit of the apparatus of the invention. Thus along with the mass of the balancing bodies and the radius of the travel paths, a further degree of freedom is obtained for the sake of achieving an optimal outcome of balancing of the rotating system.

A liquid that is introduced in addition to the balancing bodies in the closed revolution conduit of the apparatus of the invention has the advantage of being able to damp the motion of the balancing masses and thus contributing to noise reduction.

A liquid can also advantageously be introduced into the revolution conduit of the balancing apparatus of the invention for the sake of reducing friction and damping. Moreover, the continuous distribution of a liquid introduced into the revolution conduit also assures an additional balancing effect that positively reinforces the contribution of the discrete balancing bodies.

A rotating system that is balanced with the apparatus of the invention has the advantage that the applicable component is continuously rebalanced during operation, so that even imbalances that change during operation or that only arise during operation, for instance from wear, defects, dirt, or corrosion, are always automatically balanced. The apparatus of the invention makes this constant automatic balancing possible in many rotating components and systems, even of relatively small size, because of its reduced installation volume and the attainable weight saving.

With the method of the invention for balancing rotating systems, many rotating systems can be automatically balanced in a very simple way.

### DRAWING

In the drawing, a plurality of exemplary embodiments of the apparatus of the invention for dynamically balancing rotating systems are shown, which are described in further detail in the ensuing description.

Shown are:

FIG. 1, the shaft of a rotating system, with an apparatus according to the invention, shown in section, concentrically surrounding the shaft, for balancing rotating systems;

FIG. 2, a second embodiment of the apparatus of the invention for balancing rotating systems;

FIG. 3, a further embodiment for a revolution conduit of an apparatus of the invention;

FIG. 4, an alternative embodiment of a revolution conduit of the apparatus of the invention shown in FIG. 3;

FIG. 5, a fifth embodiment of a revolution conduit of the apparatus of the invention for balancing rotating systems; and

FIG. 6, an alternative embodiment of a revolution conduit of the apparatus of the invention of FIG. 5.

### DESCRIPTION OF THE EXEMPLARY EMBODIMENTS

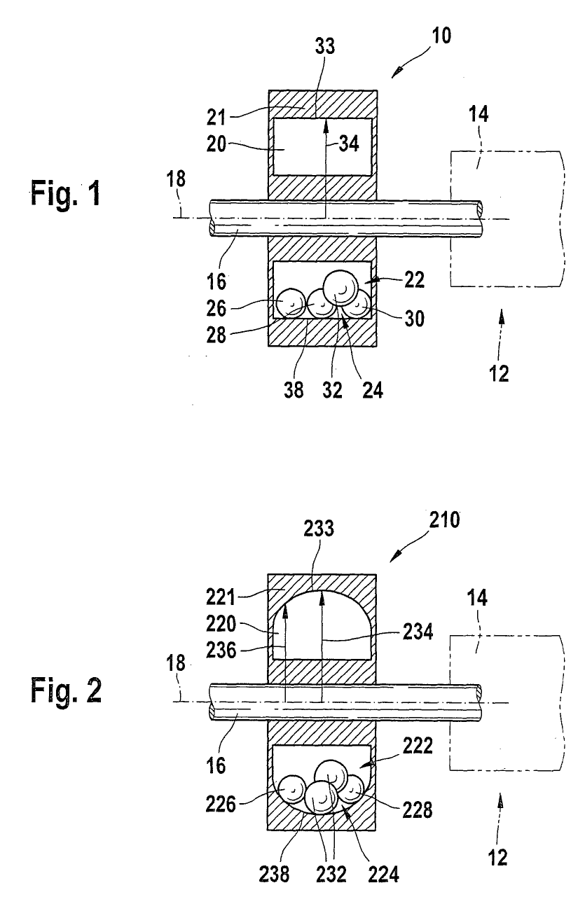

FIG. 1 shows a first exemplary embodiment of the apparatus 10 of the invention for balancing rotating systems. The rotating system 12, which in this exemplary embodiment is shown only in the form of a schematic assembly 14, is seated on a shaft 16 that is driven by the rotating system 12. The shaft 16 rotates about a pivot axis 18. In other embodiments, it is understood that it is also possible for the rotating system 12 to be driven by the shaft 16.

As possible examples, and not as a limitation for the usability of the apparatus and the method of the invention, electric motors may be mentioned, along with all rotating units driven by electric motors. Both the electric motor itself and units driven by the motor can be balanced by the apparatus of the invention or with the aid of the method of the invention. Thus instead of being a driving electric motor, the rotating system 12, which is also shown only schematically in the ensuing exemplary embodiments, can also be a fan or ventilator, or an engine cooling fan.

The apparatus 10 of the invention for automatically balancing rotating systems 12, in the exemplary embodiment of FIG. 1, has a balancing construction 21, mounted solidly on the shaft 16, in which construction a single, closed revolution conduit 20 extending concentrically about the pivot axis 18 is embodied.

In the exemplary embodiment shown here, the apparatus 10 of the invention is seated, with its balancing construction 21, on the shaft 16 separately from the actual rotating system 12 itself. In other exemplary embodiments, however, the balancing construction can be integrated with the rotating system 12 itself instead.

In the revolution conduit 20 of the apparatus 10 of the invention, there are freely movable balancing bodies 22, which in the first exemplary embodiment shown in FIG. 1 comprise balls 24 of two different diameters. The balls 26, 28, 30 have a reduced radius in FIG. 1, compared to the balls 32.

In the exemplary embodiment of FIG. 1, the revolution conduit 20 has a rectangular cross-sectional contour 33, whose dimensions are adapted to the diameters of the balls 24 in such a way that all the balls 24 can orbit the pivot axis 18 of the rotating system 12 over orbiting paths of the same radius 34 on the inner wall 38 of the conduit 20. The apparatus 10 of the invention having the balancing construction 21 of the exemplary embodiment of FIG. 1 thus makes it possible to have balls of different masses to orbit the pivot axis 18 of the system 12 along different paths within a single revolution conduit 20.

In the exemplary embodiment of FIG. 1, an adaptation of the additional moments of inertia required for optimal balancing can be made both by how the size of the outer radius 34 of the revolution conduit 20 is defined and by varying the masses of the individual balls 24.

FIG. 2 shows a further embodiment of the invention in a highly simplified illustration. Elements and components of the apparatus of the invention that are unchanged in FIG. 2 compared to the exemplary embodiment of FIG. 1 are identified by the same reference numerals. Components of the apparatus of the invention that are modified for this new exemplary embodiment have been assigned a reference numeral increased by 200, for the sake of easier comparison.

In FIG. 2, an apparatus 210 of the invention is shown, in the form of a balancing construction 221 that is solidly connected to a shaft 16 of a rotating system 12. The balancing construction 221 has a single, closed revolution conduit 220 extending concentrically about the pivot axis 18 of a shaft 16.

The revolution conduit 220, on its wall 240 remote from the shaft 16, has a radius 234 that varies in the axial direction of the assembly. Balancing bodies 22 that come to be disposed axially side by side during the operation of the rotating system 12 thus have a different spacing from the pivot axis 18 of the system 12. The embodiment shown in FIG. 2 of the apparatus of the invention thus makes different orbit radii possible for the balancing bodies 222 located in the revolution conduit 220. As examples in FIG. 2, only two possible orbit radii 234 and 236 are shown for the balancing bodies 222. Depending on their size and mass, the balancing bodies 222, which in FIG. 2 are again shown in the form of balls 224, will automatically, upon startup of the rotating system 12, come to be arranged on the inner wall 238 of the revolution conduit 220 in such a way that they move side by side along radially different travel paths about the pivot axis 18 of the system 12 to be balanced. The larger balls 232 will come to be located preferentially at the greater radius 234, while conversely smaller balls 226, 228 will be disposed axially next to them.

In this embodiment of the apparatus 210 of the invention, an optimized reduction of imbalance can be performed by varying the radius of curvature 234 of the revolution conduit 220 as well as by adapting the masses and sizes of the balancing bodies 222.

In general, by means of the special design and shape of the cross-sectional contour 33 of the single revolution conduit 20 of the apparatus 10 of the invention, it is possible, despite the use of only a single, closed conduit 20, to define a plurality of separate orbit paths about the pivot axis 18 of the system 12, which when different balancing masses are used allow optimized balancing of the rotating system 12. The especially desired, both radial and axial disposition and staggering of the various balancing masses within the single revolution conduit 20 is determined by the particular shape of the inner wall 38 (that is, the cross-sectional contour) of the single revolution conduit 20 and by the interaction of the various balancing bodies with one another.

Below, several preferred embodiments of the apparatus 10 of the invention will be described in further detail in conjunction with different forms of the cross section for the applicable revolution conduit.

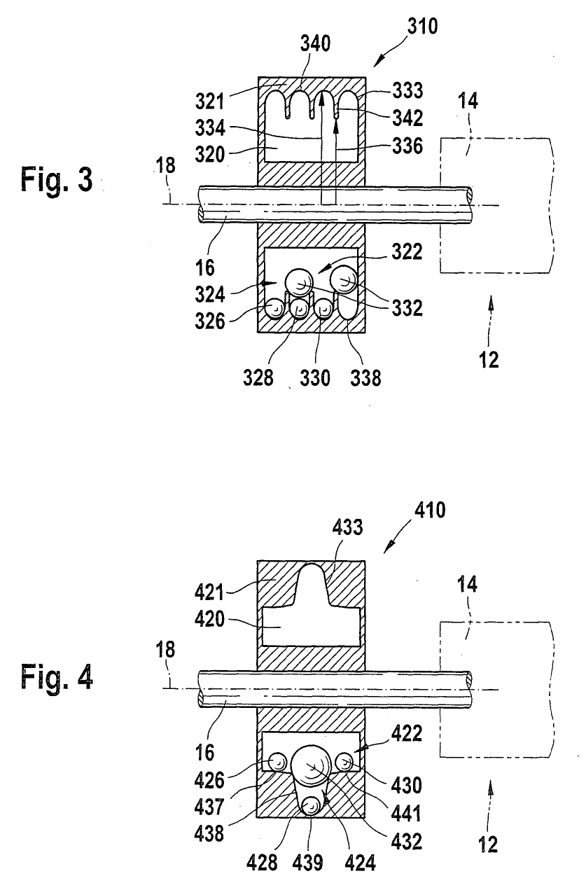

FIG. 3, in a third embodiment of the apparatus 310 of the invention, shows a revolution conduit 320 that makes it possible for the balancing bodies 322, by reason of their different size, to be disposed along orbit paths of different radii 334 and 336. By means of a purposeful design of the geometry of the inner wall 338 of the outer side 340, that is, the side remote from the shaft 16, of the revolution conduit 320, the balancing bodies 322 can be selected and forced along the desired paths by means of the radii of curvature of the possible travel path cross sections. The mutual hindrance of the balls 324 is reduced markedly by the defined separation of the travel paths within the revolution conduit 320. The balls 324 are sorted by their diameters and travel along different travel paths about the shaft 16 of the system 12. This makes it possible for the required ball sizes, number of balls, and ball masses to be defined precisely for the sake of optimally reducing the imbalance of a rotating system. Interfering effects of the kind that can occur from interaction of the balancing bodies 322 are reduced by the apparatus of the invention shown in FIG. 3. Nevertheless, the advantage that the apparatus of the invention requires only little installation space is preserved, especially since the webs 342 shown in FIG. 3 between the travel paths can be reduced to an extent that is adapted to the ball sizes.

FIG. 4 shows an alternative embodiment of a revolution conduit of the apparatus 410 of the invention, which again functions by the principle presented in conjunction with FIG. 3. In the single revolution conduit 420 of this exemplary embodiment, the balancing bodies 422, in the form of balls 424, are again separated from one another by the radii of curvature of the travel path cross sections on the inner wall 438 of the revolution conduit 420, and are thus forced along different orbit paths about the pivot axis 18 of the system 12. The disadvantage that exists in the embodiment of FIG. 3, which is that the balls (326, 328, 330) might possibly collect and be caught in the smaller paths in a statistical distribution, which in turn would lead to the generation of an additional imbalance, no longer exists with the construction of the apparatus 410 of the invention in accordance with the exemplary embodiment of FIG. 4.

The embodiment of the apparatus 410 of the invention shown in FIG. 4 makes it possible, in a structurally very simple way, to embody different, separate travel paths around the pivot axis in a single closed revolution conduit 420. The different travel paths are not demarcated sharply from one another but instead are determined merely by the geometry of the cross-sectional contour 433 of the revolution conduit 420, in conjunction with the size and interaction of the balancing bodies with one another.

The travel paths along which the balancing bodies 422 move around the common pivot axis 18 of the system 12 can be designed variously in the apparatus of the invention. While the larger balls 432 in exemplary embodiment 4 are guided at two contact points by the radius of curvature of the cross-sectional contour, the smaller balls 326, 328, 330 roll on the respective travel path with a single-point contact. The rolling faces 437, 439, 441 of the travel paths of the smaller balls 426, 428, 430 in exemplary embodiment 4 are essentially planar and have only a slight curvature, in the region of the transition toward the adjacent travel path. Moreover, travel paths with a convex or concave cross section can advantageously be used as well.

The allocation of the individual balancing bodies 422 to the respective orbit path can be reinforced by means of the order in which the revolution conduit 420 is filled with the balancing masses. By means of this kind of embodiment and by filling the conduit with only a few balls—relative to the radius of the travel path—the mutual hindrance of the balancing bodies is minimized. When the system 12 is accelerated to operating speed, the smaller balls 426, 428, 430 will move outward by centrifugal force, unless they have already collected on the lowermost path by the force of gravity before the system starts up.

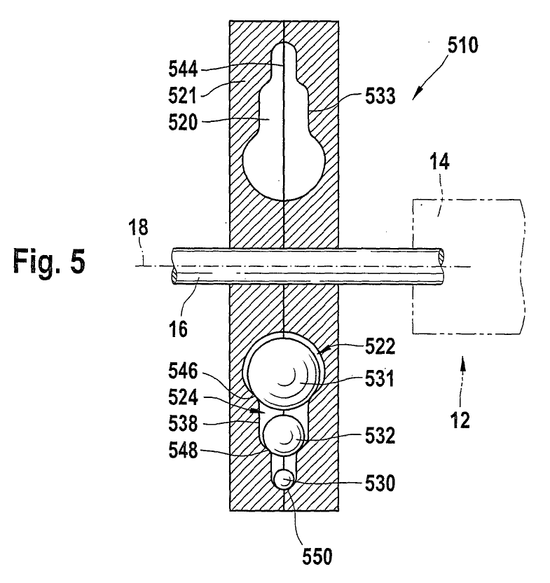

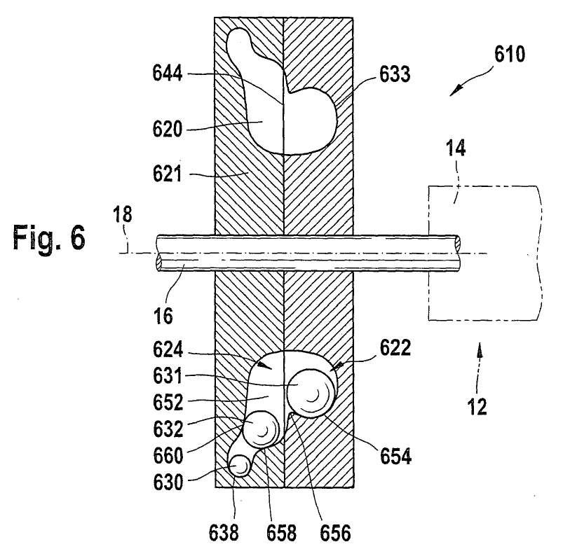

A further modification of the exemplary embodiment of the apparatus of the invention shown in FIG. 4 is shown in FIGS. 5 and 6. FIGS. 5 and 6, each in cross section, show one example of an advantageous form of the cross-sectional contour of a revolution conduit 520 and 620, respectively, of the apparatus of the invention. A balancing construction 521 and 621, respectively, which is seated firmly on the shaft 16 of the rotating system 12, can also be seen in FIGS. 5 and 6. In the balancing construction 521 and 621, a respective revolution conduit 520 and 620 with an optimized cross-sectional contour 533 and 633 is embodied, which extends concentrically about the shaft 16 of the rotating system 12.

FIGS. 5 and 6 furthermore each show a respective parting plane 544 and 644 in the balancing construction 521 and 621, respectively, at which the apparatus of the invention can be opened and thus easily filled with the desired number of applicable balls.

FIG. 5 shows the embodiment of three separate travel paths in axially staggered fashion in the single revolution conduit 520 of the balancing apparatus 510 by means of a suitable variation of the form of the cross section 533 of the revolution conduit 520. In this exemplary embodiment, balls 524 of three different diameters 530, 531, 532 orbit around the pivot axis 18 of the system 12 along the three orbit paths shown. In the exemplary embodiment shown, the ball diameter of the balancing bodies 522 decreases with increasing spacing from the pivot axis 18 of the system 12. Other kinds of staggering of the balancing bodies 522 are also conceivable, however, and can be achieved in a simple way by suitable shaping of the cross-sectional contour 533 of the revolution conduit 520. A previously determined number of balls 524 of the desired size can be placed on each of the orbit paths. By way of the density of the material comprising the ball, it is possible—despite a predetermined ball radius—to vary the ball mass and thus the moment of inertia made available for balancing purposes. The larger balls 531 and 532, in the exemplary embodiment of FIG. 5, no longer roll on the respective travel path with a single-point contact, but rather with a two-point contact, which has the additional advantage of a very precisely defined path course. The rolling faces 546, 548, 550 of the balancing bodies 522, in other words the particular portions of the surface of the inner wall of the revolution conduit 520 on which portions the balancing bodies 522 orbit the pivot axis 18 of the system 12 in operation, are curved toward the plane of symmetry of the arrangement, in the example shown in FIG. 5, in such a way that the applicable ball centers itself automatically on its travel path. The same effect can also be attained with intrinsically straight rolling faces that are inclined to the pivot axis 18. Axial rolling faces extending parallel to the pivot axis 18 are also conceivable, but they enable self-centering of the balancing bodies 522 on the applicable travel path only to a limited extent.

The embodiment of the revolution conduit 520 in the region of transition of the individual travel paths from one to another is shown in FIG. 5 only as an example in the form of rounded places and is not intended to limit the range of possible embodiments of the apparatus of the invention.

In an augmentation of the exemplary embodiment of FIG. 5, the individual travel paths of the balancing apparatus 610 of the invention shown in FIG. 6 have, in addition to the radial staggering, an axial offset from one another in the direction of the pivot axis 18 of the rotating system 12. The axial offset of the travel paths in this exemplary embodiment is dependent on the ratio of the ball diameter to the travel path diameter. In exemplary embodiment 6, the largest balancing body 638 has the smallest spacing from the pivot axis 18 of the system 12. A free space 652 remains in the revolution conduit 620 axially next to the balancing body 638, and this space makes it possible for the balls 630 and 632 to find enough place axially next to the ball 638 even in the sectional plane of the apparatus 610 of the invention shown in FIG. 6. The balls 638 run in a kind of travel depression 654, which demarcates the travel path of the balls 638 from the further travel paths by means of a kind of hump 656. The travel depression 654 thus creates a concave rolling face for the balls 638, which can thus be held stably on their travel path. The travel path of the balls 632 is not formed by a travel depression but instead is defined by a curved rolling face 658 and a conversely acting contact face 660.

The invention is not limited to the exemplary embodiments described of a single revolution conduit provided only with balancing masses.

The function of the balancing unit can be improved by using damping fluids, such as oil, of constant viscosity, or by means of friction-reducing fluids.

Nor is the apparatus of the invention limited to the use of balls as balancing bodies. In principle, balancing bodies of the most various shapes can be used in the apparatus of the invention.

The number of orbit paths shown in the exemplary embodiments within the single revolution conduit of the apparatus of the invention for dynamically balancing rotating systems is meant to be considered solely as an example and does not preclude the use of some different number of orbit paths.

1. An apparatus (10, 210, 310, 410, 510, 610) for balancing a system (12) rotating about a pivot axis (18), with travel paths arranged around the pivot axis of the system (12) for at least one movable balancing body (22, 222, 322, 422, 522, 622), characterized in that a closed revolution conduit (20, 220, 320, 420, 520, 620) extending concentrically about the pivot axis (18) of the system (12) is provided, in which a plurality of travel paths, open toward one another, are embodied about the common pivot axis (18) of the rotating system (12).

2. The apparatus of claim 1, characterized in that the travel paths are formed out of the inner wall (38, 238, 338, 438, 538, 638) of the revolution conduit (20, 220, 320, 420, 520, 620) by means of its cross-sectional contour (33, 233, 333, 433, 533, 633).

3. The apparatus of claim 1 or 2, characterized in that a plurality of balancing bodies (22, 222, 322, 422, 522, 622) of various sizes can orbit along the various travel paths within the revolution conduit (33, 233, 333, 433, 533, 633) around the common pivot axis (18) of the rotating system (12).

4. The apparatus of claim 3, characterized in that the cross-sectional contour (33, 233, 333, 433, 533, 633) of the revolution conduit (33, 233, 333, 433, 533, 633) is formed out such that staggering of the existing balancing bodies (22, 222, 322, 422, 522, 622) in the radial and/or axial direction exists.

5. The apparatus of one of the foregoing claims, characterized by balancing bodies (22, 222, 322, 422, 522, 622) that differ in mass.

6. The apparatus of claim 5, characterized in that the balancing bodies (22, 222, 322, 422, 522, 622) are balls (24, 224, 324, 424, 524, 624).

7. The apparatus of claim 6, characterized in that the balls (24, 224, 324, 424, 524, 624) have at least two different diameters.

8. The apparatus of one of the foregoing claims, characterized in that along with the balancing bodies (22, 222, 322, 422, 522, 622), a liquid is also located in the revolution conduit (20, 220, 320, 420, 520, 620).

9. A rotating system (12) with a pivot axis (18) and with an apparatus (10, 210, 310, 410, 510, 610) for automatically balancing the system (12), of one of claims 1-8.

10. A method for balancing rotating systems (12), having a pivot axis (18), using travel paths, disposed about the pivot axis (18) of the system (12), for movable balancing bodies (22, 222, 322, 422, 522, 622), characterized in that the balancing bodies (22, 222, 322, 422, 522, 622), during the operation of the system (12), orbit in a closed revolution conduit (20, 220, 320, 420, 520, 620), extending concentrically about the pivot axis (18) of the system, on the travel paths formed out on the inner wall (38, 238, 338, 438, 538, 638) of the conduit (20, 220, 320, 420, 520, 620) by means of its cross-sectional contour (33, 233, 333, 433, 533, 633), and are distributed in the travel paths in such a way, over the entire circumference of the conduit (20, 220, 320, 420, 520, 620), that the imbalance of the overall system is reduced.
New claims

11. An apparatus (10, 210, 310, 410, 510, 610) for balancing a system (12) rotating about a pivot axis (18), with travel paths arranged around the pivot axis of the system (12) for at least one movable balancing body (22, 222, 322, 422, 522, 622), characterized in that a closed revolution conduit (20, 220, 320, 420, 520, 620) extending concentrically about the pivot axis (18) of the system (12) is provided, in which a plurality of travel paths, open toward one another, are embodied about the common pivot axis (18) of the rotating system (12).

12. The apparatus of claim 11, characterized in that the travel paths are formed out of the inner wall (38, 238, 338, 438, 538, 638) of the revolution conduit (20, 220, 320, 420, 520, 620) by means of its cross-sectional contour (33, 233, 333, 433, 533, 633).

13. The apparatus of claim 11, characterized in that a plurality of balancing bodies (22, 222, 322, 422, 522, 622) of various sizes can orbit along the various travel paths within the revolution conduit (33, 233, 333, 433, 533, 633) around the common pivot axis (18) of the rotating system (12).

14. The apparatus of claim 13, characterized in that the cross-sectional contour (33, 233, 333, 433, 533, 633) of the revolution conduit (33, 233, 333, 433, 533, 633) is formed out such that staggering of the existing balancing bodies (22, 222, 322, 422, 522, 622) in the radial and/or axial direction exists.

15. The apparatus of claim 11, characterized by balancing bodies (22, 222, 322, 422, 522, 622) that differ in mass.

16. The apparatus of claim 15, characterized in that the balancing bodies (22, 222, 322, 422, 522, 622) are balls (24, 224, 324, 424, 524, 624).

17. The apparatus of claim 16, characterized in that the balls (24, 224, 324, 424, 524, 624) have at least two different diameters.

18. The apparatus of claim 11, characterized in that along with the balancing bodies (22, 222, 322, 422, 522, 622), a liquid is also located in the revolution conduit (20, 220, 320, 420, 520, 620).

19. A rotating system (12) with a pivot axis (18) and with an apparatus (10, 210, 310, 410, 510, 610) for automatically balancing the system (12), of claim 11.

20. A method for balancing rotating systems (12), having a pivot axis (18), using travel paths, disposed about the pivot axis (18) of the system (12), for movable balancing bodies (22, 222, 322, 422, 522, 622), characterized in that the balancing bodies (22, 222, 322, 422, 522, 622), during the operation of the system (12), orbit in a closed revolution conduit (20, 220, 320, 420, 520, 620), extending concentrically about the pivot axis (18) of the system, on the travel paths formed out on the inner wall (38, 238, 338, 438, 538, 638) of the conduit (20, 220, 320, 420, 520, 620) by means of its cross-sectional contour (33, 233, 333, 433, 533, 633), and are distributed in the travel paths in such a way, over the entire circumference of the conduit (20, 220, 320, 420, 520, 620), that the imbalance of the overall system is reduced.
